(19) United States
(12) Patent Application Publication
(10) Pub. No.: US 2014/0285379 A1
(43) Pub. Date: Sep. 25, 2014

(54) MONITORING DEVICE AND DOPPLER VOR SYSTEM

(71) Applicant: Kabushiki Kaisha Toshiba, Minato-ku (JP)

(72) Inventor: Yoshio KAWAGUCHI, Yokohama-shi (JP)

(73) Assignee: Kabushiki Kaisha Toshiba, Minato-ku (JP)

(21) Appl. No.: 14/147,729

(22) Filed: Jan. 6, 2014

(30) Foreign Application Priority Data
Mar. 25, 2013 (JP) 2013-062495

(51) Int. Cl. G01S 1/50; G01S 1/08

(52) U.S. Cl. CPC G01S 1/50; G01S 1/08
USPC 342/406; 342/418

(57) ABSTRACT

According to one embodiment, a monitoring device includes a monitoring antenna, a frequency converter, a filter, a detector, and an azimuth detector. The monitoring antenna receives a carrier wave, an upper sideband wave, and a lower sideband wave as a VOR signal. The frequency converter converts a frequency band of the VOR signal into an IF band. The filter includes passband. The passband removes a component of the lower sideband wave in the VOR signal. The detector detects a component of the carrier wave, and a component of the upper sideband wave from the signal output from the filter. The azimuth detector detects an azimuth based on the detected carrier wave component, and the detected upper sideband wave component.

### CROSS-REFERENCE TO RELATED APPLICATIONS

This application is based upon and claims the benefit of priority from prior Japanese Patent Application No. 2013-062495, filed Mar. 25, 2013, the entire contents of which are incorporated herein by reference.

### FIELD

Embodiments described herein relate generally to a monitoring device and a Doppler VOR system.

### BACKGROUND

In order to monitor a VOR signal radiated from a double sideband Doppler VHF omnidirectional radio range (DSB Doppler VOR) transmitting device at close range, a conventional monitoring device removes a carrier component included in a VOR signal received by a monitoring antenna on the basis of a carrier wave supplied thereto from a DSB Doppler VOR transmitting device through a carrier feeder line. The monitoring device adjusts a phase of the carrier wave supplied thereto from the carrier feeder line on the basis of a path difference between a path from a carrier antenna to the monitoring antenna, and path from a sideband antenna arranged around the carrier antenna along a circle having a diameter of 13 meters to the monitoring antenna. That is, the monitoring device adjusts the phase of the carrier wave in such a manner that a phase lag of an upper sideband wave, and phase lag of a lower sideband wave radiated from the sideband antennas are corrected. Further, the monitoring device newly injects the carrier wave the phase of which has been adjusted into the signal from which the carrier component has been removed.

In this way, the monitoring device avoids a drop (received signal discontinuity) in intensity of the VOR signal based on the phase lag of the upper sideband wave, and phase lag of the lower sideband wave relative to the carrier wave, the phase lag of the upper sideband wave, and phase lag of the lower sideband wave being caused by the path difference between the carrier antenna, and sideband antenna, and creates a VOR signal equivalent to that of distant reception. Thereby, it becomes possible to monitor a VOR signal radiated from the DSB Doppler VOR transmitting device at close range.

However, in the conventional monitoring device, it is hard to carry out processing of adjusting the phase of the carrier wave supplied from the DSB Doppler VOR transmitting device in such a manner that the phase of the carrier wave becomes 180° out of phase with that of the carrier wave included in the VOR signal, and processing of adjusting the phase of the supplied carrier wave in such a manner that the phase lags of the upper and lower sideband waves are corrected. Accordingly, the monitoring device takes a lot of time to carry out the processing of these adjustments. Further, in the conventional monitoring device, the phase lags are resolved by newly injecting the carrier wave the phase of which has been adjusted to correct the phase lags into the signal. However, in order to make the VOR signal equivalent to that of distant reception, it is necessary to install the monitoring antenna at a position separate from the carrier antenna by more than a predetermined distance, for example, 25 meters.

### BRIEF DESCRIPTION OF THE VIEWS OF THE DRAWING

FIG. 1 is a view showing the configuration of a Doppler VOR system according to an embodiment;

FIG. 2 is a block diagram showing the functional configuration of a DSB Doppler VOR transmitting device shown in FIG. 1;

FIG. 3 is a block diagram showing the functional configuration of a first monitoring device shown in FIG. 1;

FIG. 4 is a block diagram showing the functional configuration of a second monitoring device shown in FIG. 1;

FIG. 5 is a view showing a detection result of an upper sideband wave of a case where a lower sideband wave is removed by using a filter shown in FIG. 3;

FIG. 6 is a view showing a detection result of the upper sideband wave of a case where the lower sideband wave is not removed;

FIG. 7 is a block diagram showing the functional configurations of a conventional DSB Doppler VOR transmitting device, and conventional monitoring device; and

FIG. 8 is a block diagram showing another functional configuration of the DSB Doppler VOR transmitting device shown in FIG. 1.

### DETAILED DESCRIPTION

In general, according to one embodiment, a monitoring device includes a monitoring antenna, a frequency converter, a filter, a detector, and an azimuth detector. The monitoring antenna receives a carrier wave radiated from a carrier antenna provided to a DSB Doppler VOR transmitting device, an upper sideband wave radiated from a plurality of sideband antennas arranged to surround the carrier antenna, and a lower sideband wave radiated from the plurality of sideband antennas as a VOR signal, and wherein the upper sideband wave is higher in frequency than the carrier wave by a preset frequency, and wherein the lower sideband wave is lower in frequency than the carrier wave by the preset frequency. The frequency converter converts a frequency band of the VOR signal into an intermediate frequency band. The filter includes passband. The passband removes a component of the lower sideband wave in the frequency-converted VOR signal. The detector detects a component of the carrier wave, and a component of the upper sideband wave from the signal output from the filter. The azimuth detector detects an azimuth based on the detected carrier wave component, and the detected upper sideband wave component.

### First Embodiment

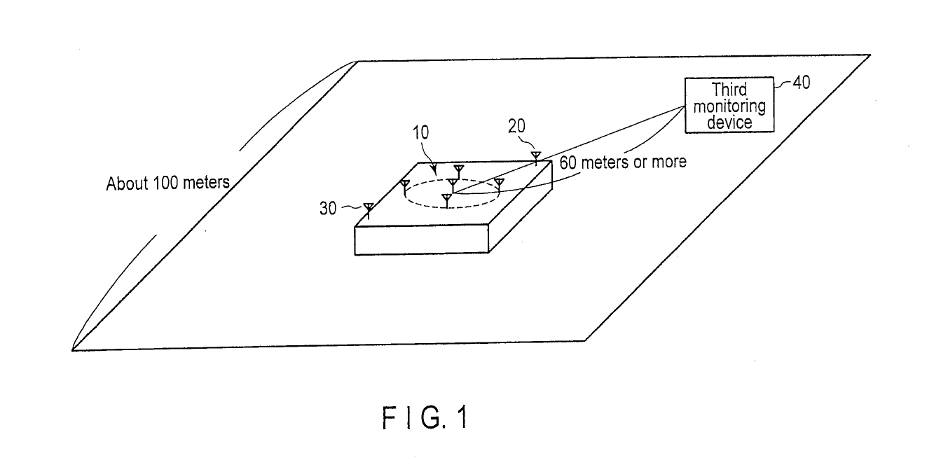

Hereinafter, an embodiment will be described with reference to the drawings. FIG. 1 is a schematic view showing the configuration of a Doppler VOR system according to the embodiment. The Doppler VOR system shown in FIG. 1 includes a DSB Doppler VOR transmitting device 10, and monitoring devices of a preset number within a preset range (for example, within a range of 100 meters in each direction) from a position at which the DSB Doppler VOR transmitting device 10 is installed. In this embodiment, the Doppler VOR system includes a first monitoring device 20, second monitoring device 30, and third monitoring device 40. The first and second monitoring devices 20, and 30 are installed in the same facility in which the DSB Doppler VOR transmitting device 10 is installed. The third monitoring device 40 is installed at a position separate from the DSB Doppler VOR transmitting device 10 by 60 meters or more. It should be noted that a distance of 60 meters or more implies a distance indicating that the third monitoring device 40 is positioned sufficiently distant from the DSB Doppler VOR transmitting device 10 to such a degree that an influence of phase lags of an upper sideband wave, and lower sideband wave transmitted from the DSB Doppler VOR transmitting device 10 can be neglected.

It should be noted that in this embodiment, although a description will be given of an example of a case where the Doppler VOR system includes the first monitoring device 20, second monitoring device 30, and third monitoring device 40, the example is not limited to this. Further, although a description will be given of an example of a case where the first monitoring device 20, and second monitoring device 30 are installed in the facility in which the DSB Doppler VOR transmitting device 10 is installed, the place at which the first monitoring device 20, and second monitoring device 30 are to be installed is not limited to the above.

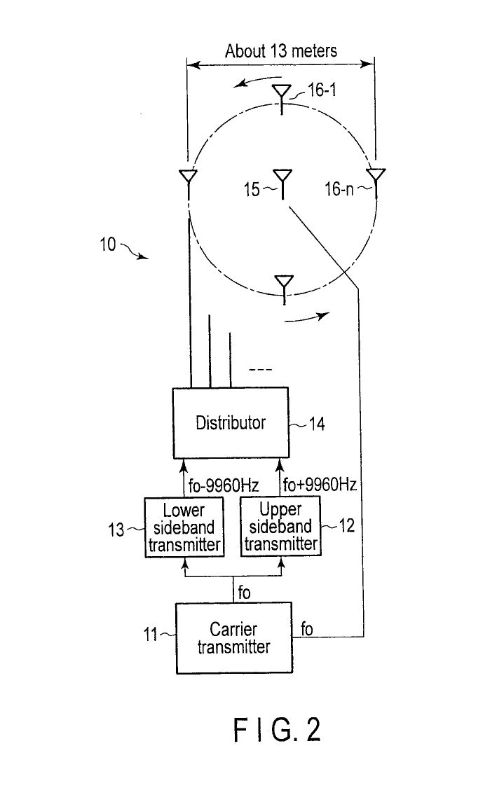

FIG. 2 is a block diagram showing the functional configuration of the DSB Doppler VOR transmitting device 10 shown in FIG. 1. The DSB Doppler VOR transmitting device 10 shown in FIG. 2 is provided with a carrier transmitter 11, upper sideband transmitter 12, lower sideband transmitter 13, distributor 14, carrier antenna 15, and sideband antennas 16-1 to 16-n (n is a natural number greater than or equal to 1).

The carrier transmitter 11 generates a carrier wave by subjecting a signal of a frequency f₀ (one wave in the 108 to 117.95 MHz band) to amplitude modulation at a frequency of 30 Hz. The carrier transmitter 11 outputs the carrier wave to the carrier antenna 15. Further, the carrier transmitter 11 outputs the signal of the frequency f₀ to the upper sideband transmitter 12, and lower sideband transmitter 13.

The upper sideband transmitter 12 utilizes the signal of the frequency f₀ supplied thereto from the carrier transmitter 11 to generate an unmodulated upper sideband wave of an upper sideband f₁ (f₀+9960 Hz). The upper sideband transmitter 12 outputs the generated upper sideband wave to the distributor 14.

The lower sideband transmitter 13 utilizes the signal of the frequency f₀ supplied thereto from the carrier transmitter 11 to generate an unmodulated lower sideband wave of a lower sideband f₂ (f₀−9960 Hz). The lower sideband transmitter 13 outputs the generated lower sideband wave to the distributor 14.

The distributor 14 distributes the upper sideband wave to the sideband antennas 16-1 to 16-n in such a manner that the sideband antennas 16-1 to 16-n radiate the upper sideband wave while rotating around the carrier antenna 15 with a preset period.

The distributor 14 distributes the lower sideband wave to the sideband antennas 16-1 to 16-n in such a manner that the sideband antennas 16-1 to 16-n radiate the lower sideband wave while rotating around the carrier antenna 15 with the preset period. At this time, the distributor 14 distributes the upper sideband wave and lower sideband wave to the sideband antennas 16-1 to 16-n in such a manner that a sideband antenna radiating the upper sideband wave, and sideband antenna radiating the lower sideband wave are positioned opposite to each other with respect to the carrier antenna 15.

The carrier antenna 15 is fixed, and radiates the carrier wave supplied thereto from the carrier transmitter 11.

The sideband antennas 16-1 to 16-n are arranged on a circle with a radius r, and arranged around the carrier antenna 15, and at positions on a level with the carrier antenna 15. The sideband antennas 16-1 to 16-n radiate the upper sideband wave and lower sideband wave supplied to them from the distributor 14. Thereby, a VOR signal is radiated from the DSB Doppler VOR transmitting device 10. When the VOR signal radiated from the DSB Doppler VOR transmitting device 10 is received at a sufficiently distant position, the VOR signal is changed into an amplitude-modulated wave signal by spatial modulation.

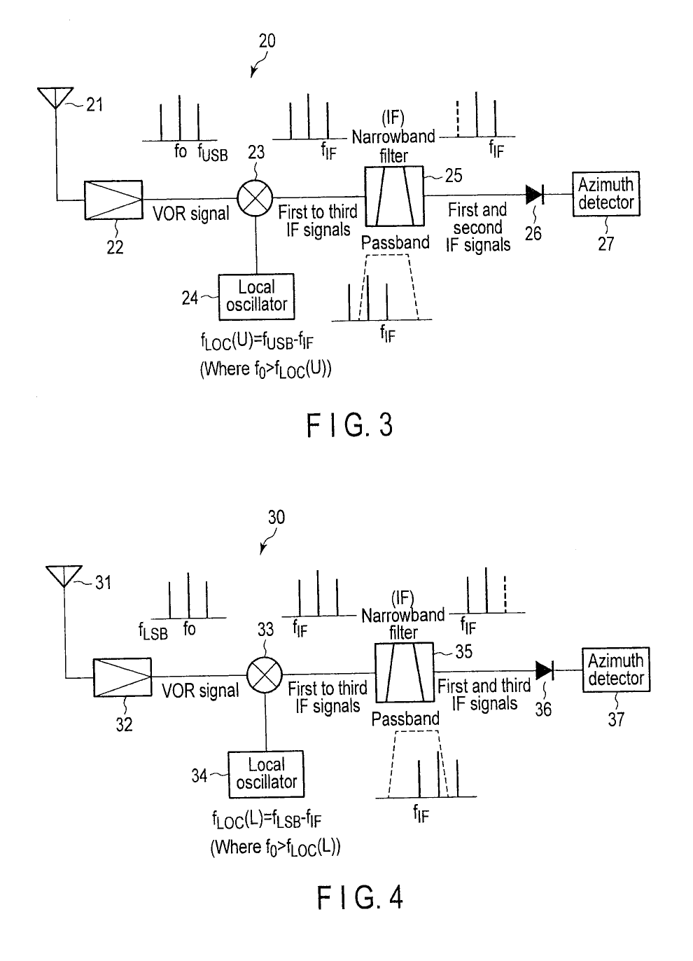

FIG. 3 is a block diagram showing the functional configuration of the first monitoring device 20 shown in FIG. 1. The first monitoring device 20 shown in FIG. 3 is provided with a monitoring antenna 21, amplifier 22, mixer 23, local oscillator 24, narrowband filter 25, detector 26, and azimuth detector 27. It should be noted that in FIG. 3, the amplifier 22, mixer 23, local oscillator 24, narrowband filter 25, detector 26, and azimuth detector 27 may be realized by software processing carried out by a signal processor.

The monitoring antenna 21 is arranged at a position on a level with the carrier antenna 15, and sideband antennas 16-1 to 16-n. The monitoring antenna 21 receives a VOR signal radiated from the DSB Doppler VOR transmitting device 10.

The amplifier 22 amplifies the VOR signal received by the monitoring antenna 21, and outputs the amplified signal to the mixer 23.

The mixer 23 utilizes a local signal supplied thereto from the local oscillator 24 to frequency-convert the frequency of the VOR signal supplied thereto from the amplifier 22 into a frequency of an intermediate frequency (IF) band. Here, the VOR signal converted into a signal of the IF band includes a first IF signal derived from the carrier wave, second IF signal derived from the upper sideband wave, and third IF signal derived from the lower sideband wave. A local signal of a frequency expressed by, for example, F_{LOC} (U)=f_{USB}−f_{IF} is supplied from the local oscillator 24 to the mixer 23. It should be noted that the frequency f_{USB} is a frequency contrived in such a manner that the third IF signal expressed by f_{IF}−2×9960 Hz is band-limited by the narrowband filter 25, and the first IF signal expressed by f_{IF}−9960 Hz, and the second IF signal expressed by f_{IF} are allowed to pass through the narrowband filter 25. The mixer 23 outputs the first to third IF signals to the narrowband filter 25.

The narrowband filter 25 has preset filter characteristics, and subjects the first to third IF signals supplied thereto from the mixer 23 to bandpass processing. By the synergistic effect of the frequency conversion processing carried out by the mixer 23, and bandpass processing carried out by the narrowband filter 25, passage of the third IF signal through the narrowband filter 25 is blocked therein. The narrowband filter 25 outputs the first and second IF signals to the detector 26.

The detector 26 detects the first and second IF signals supplied thereto from the narrowband filter 25, and outputs a first detection result obtained by detecting the first IF signal, and second detection result obtained by detecting the second IF signal to the azimuth detector 27.

The azimuth detector 27 detects an azimuth by using a beat signal obtained from the first IF signal and second IF signal on the basis of the first and second detection results.

FIG. 4 is a block diagram showing the functional configuration of the second monitoring device 30 shown in FIG. 1. The second monitoring device 30 shown in FIG. 4 is provided with a monitoring antenna 31, amplifier 32, mixer 33, local oscillator 34, narrowband filter 35, detector 36, and azimuth detector 37. It should be noted that in FIG. 4, the amplifier 32, mixer 33, local oscillator 34, narrowband filter 35, detector 36, and azimuth detector 37 may be realized by software processing carried out by a signal processor.

The monitoring antenna 31 is arranged at a position on a level with the carrier antenna 15, and sideband antennas 16-1 to 16-n. The monitoring antenna 31 receives a VOR signal radiated from the DSB Doppler VOR transmitting device 10.

The amplifier 32 amplifies the VOR signal received by the monitoring antenna 31, and outputs the amplified signal to the mixer 33.

The mixer 33 utilizes a local signal supplied thereto from the local oscillator 34 to frequency-convert the frequency of the VOR signal supplied thereto from the amplifier 32 into a frequency of an IF band. A local signal of a frequency expressed by, for example, (L)=f_{LSB}−f_{IF} is supplied from the local oscillator 34 to the mixer 33. It should be noted that the frequency f_{LSB} is a frequency contrived in such a manner that the second IF signal expressed by f_{IF}+2×9960 Hz is band-limited by the narrowband filter 35, and the third IF signal expressed by f_{IF}, and the first IF signal expressed by f_{IF}+9960 Hz are allowed to pass through the narrowband filter 35. The mixer 33 outputs the first to third IF signals to the narrowband filter 35.

The narrowband filter 35 has preset filter characteristics, and subjects the first to third IF signals supplied thereto from the mixer 33 to bandpass processing. By the synergistic effect of the frequency conversion processing carried out by the mixer 33, and bandpass processing carried out by the narrowband filter 35, passage of the second IF signal through the narrowband filter 35 is blocked therein. The narrowband filter 35 outputs the first and third IF signals to the detector 36.

The detector 36 detects the first and third IF signals supplied thereto from the narrowband filter 35, and outputs a first detection result obtained by detecting the first IF signal, and third detection result obtained by detecting the third IF signal to the azimuth detector 37.

The azimuth detector 37 detects an azimuth by using a beat signal obtained from the first IF signal and third IF signal on the basis of the first and third detection results.

The third monitoring device 40 is arranged at a position sufficiently distant from the DSB Doppler VOR transmitting device by 60 meters or more, and hence receives a VOR signal changed into an amplitude-modulated wave signal by spatial modulation. The third monitoring device 40 detects an azimuth on the basis of the received VOR signal.

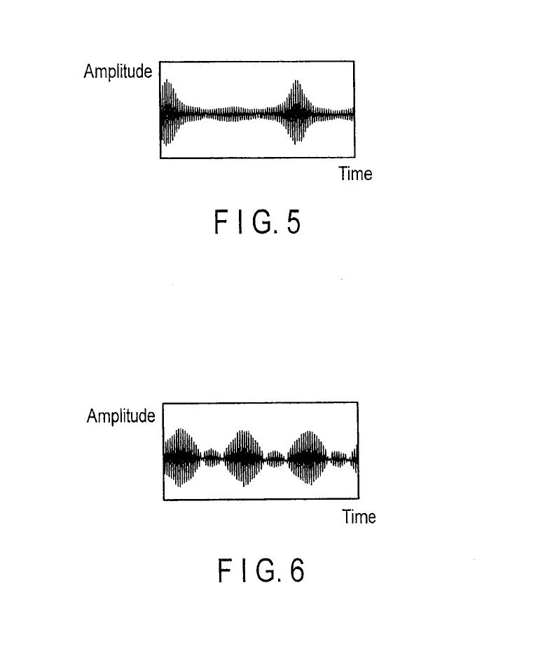

FIG. 5, and FIG. 6 are views each showing a detection result of the second IF signal in the case where the first monitoring device 20 is arranged at a position of a distance of 15 meters from the DSB Doppler VOR transmitting device 10 with an azimuth of 240°. FIG. 5 shows the detection result of the case where the third IF signal is removed by the narrowband filter 25, and FIG. 6 shows the detection result of the case where the third IF signal is not removed. It should be noted that in FIG. 5, and FIG. 6, the abscissa axis indicates time, and the ordinate axis indicates amplitude. In FIG. 6, the amplitude of the second IF signal has a constricted shape, and has discontinuous parts. However, in FIG. 5, it can be seen that the constricted shape is resolved.

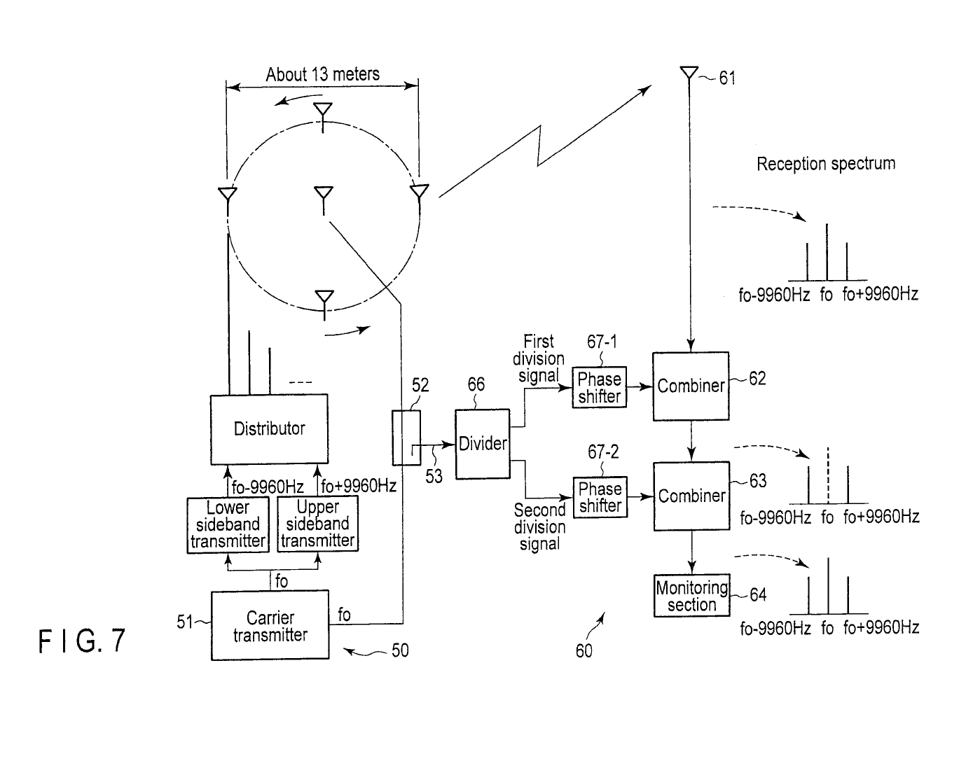

Hereinafter, the functional configurations of the conventional DSB Doppler VOR transmitting device 50, and monitoring device 60 will be described with reference to the block diagram shown in FIG. 7.

The monitoring device 60 shown in FIG. 7 is connected to the DSB Doppler VOR transmitting device 50 through a feeder line 53. A carrier wave output from a carrier transmitter 51 of the DSB Doppler VOR transmitting device 50 is branched by a directivity coupler 52, and the branched carrier wave is supplied to the monitoring device 60 through the feeder line 53.

The monitoring device 60 divides the carrier wave supplied thereto from the DSB Doppler VOR transmitting device 50 into first and second division signals by using a divider 66. The divider 66 outputs the first division signal to a phase shifter 67-1, and outputs the second division signal to a phase shifter 67-2.

The phase shifter 67-1 adjusts a phase of the first division signal in such a manner that the phase becomes 180° out of phase with a phase of a carrier wave included in a VOR signal received by a monitoring antenna 61. The phase shifter 67-2 adjusts a phase of the second division signal in such a manner that a phase difference between the carrier wave included in the VOR signal and upper sideband wave, and a phase difference between the carrier wave and lower sideband wave are corrected.

A combiner 62 removes the carrier wave from the VOR signal by combining the VOR signal received by the monitoring antenna 61 with the first division signal the phase of which is adjusted. A combiner 63 creates a VOR signal equivalent to that of distant reception by combining the signal from which the carrier wave has been removed by the combiner 62 with the second division signal the phase of which is adjusted. A monitoring section 64 detects an azimuth on the basis of the VOR signal newly created by the combiner 63. It should be noted that the monitoring device 60 resolves a phase lag of the upper sideband wave relative to the carrier wave, and phase lag of the lower sideband wave relative to the carrier wave by combination of the second division signal the phase of which is adjusted, and hence it is necessary to install the monitoring device 60 at a position distant from the carrier antenna by 25 meters or more.

Conversely, in this embodiment, the first monitoring device 20 removes the third IF signal derived from the lower sideband wave by using the narrowband filter 25, and detects the azimuth by using the first and second IF signals which are allowed to pass through the narrowband filter 25. Further, the second monitoring device 30 removes the second IF signal derived from the upper sideband wave by using the narrowband filter 35, and detects the azimuth by using the first and third IF signals which are allowed to pass through the narrowband filter 35. That is, each of the first and second monitoring devices 20 and 30 detects the azimuth by utilizing the single sideband (SSB) system. Thereby, the first and second monitoring devices 20 and 30 become free from the influence of a phase lag of the upper sideband wave relative to the carrier wave, and phase lag of the lower sideband wave relative to the carrier wave, and hence it becomes possible to install the first and second monitoring devices 20 and 30 at arbitrary positions irrespective of the distance from the carrier antenna 15.

When the conventional monitoring device 60 is to be installed, it is necessary to provide the monitoring antenna 61 at a position separate from the carrier antenna by 25 meters or more, and at a position on a level with the carrier antenna, and sideband antennas. The carrier antenna, and sideband antennas are generally installed at positions somewhat higher than the ground surface, and hence the monitoring antenna 61 should be provided at a position higher than the ground surface. According to the first monitoring device 20 of this embodiment, it is possible to install the first monitoring device 20 in the facility in which the DSB Doppler VOR transmitting device 10 is installed, and it is not necessary to independently provide the monitoring antenna 21 at a position higher than the ground surface, and hence it becomes easy to install the first monitoring device 20. Further, according to the second monitoring device 30 of this embodiment, it is possible to install the second monitoring device 30 in the facility in which the DSB Doppler VOR transmitting device 10 is installed, and it is not necessary to independently provide the monitoring antenna 31 at a position higher than the ground surface, and hence it becomes easy to install the second monitoring device 30.

Further, it is possible for the first monitoring device 20 according to this embodiment to detect an azimuth on the basis of the carrier wave and upper sideband wave without adjusting the phases of the first and second division signals, unlike the conventional monitoring device 60.

Further, it is possible for the second monitoring device 30 according to this embodiment to detect an azimuth on the basis of the carrier wave and lower sideband wave without adjusting the phases of the first and second division signals, unlike the conventional monitoring device 60. Therefore, according to the first and second monitoring devices 20 and 30 of this embodiment, a lot of time is not spent in phase adjustment.

Further, in the conventional monitoring device 60, for example, when the feeder line 53 constituted of a coaxial cable is deteriorated by secular changes, the phase of the carrier wave to be supplied to the monitoring device 60 is changed. The phase adjustment to be carried out by the phase shifters 67-1 and 67-2 is based on the assumption that the phase of the carrier wave of the VOR signal received by the monitoring antenna 61, and the phase of the carrier wave supplied through the feeder line 53 coincide with each other, and hence when the feeder line 53 is deteriorated by secular changes, the azimuth detection to be carried out by the monitoring device 60 becomes unstable. On the other hand, in the first and second monitoring devices 20 and 30 according to this embodiment, it is not necessary to provide the feeder line 53, and hence the azimuth detection never becomes unstable due to aging deterioration.

Further, in the conventional monitoring device 60, even when an abnormality occurs in the upper sideband transmitter of the DSB Doppler VOR transmitting device 50, it has not been possible to determine in which of the upper sideband transmitter and lower sideband transmitter the abnormality has occurred. On the other hand, according to the first monitoring device 20 of this embodiment, when an abnormality occurs in the upper sideband transmitter 12, it becomes possible to determine that the abnormality has occurred in the upper sideband transmitter 12.

Further, in the conventional monitoring device 60, even when an abnormality occurs in the lower sideband transmitter of the DSB Doppler VOR transmitting device 50, it has not been possible to determine in which of the upper sideband transmitter and lower sideband transmitter the abnormality has occurred. On the other hand, according to the second monitoring device 30 of this embodiment, when an abnormality occurs in the lower sideband transmitter 13, it becomes possible to determine that the abnormality has occurred in the lower sideband transmitter 13.

Therefore, according to the first and second monitoring devices 20 and 30 of this embodiment, it is possible to monitor the VOR signal without spending a lot of time on phase adjustment, and without any restriction on the installation distance.

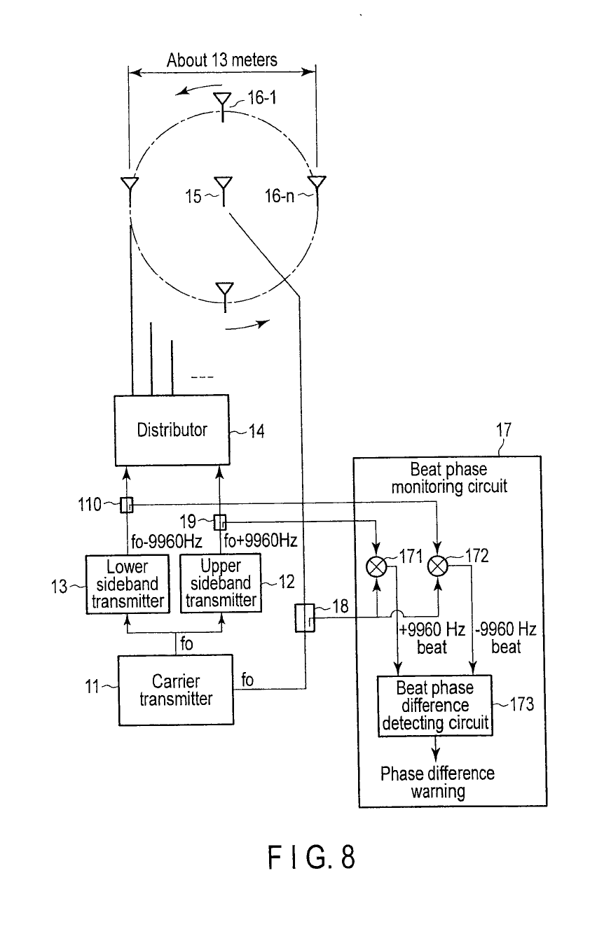

Further, the functional configuration of the DSB Doppler VOR transmitting device 10 is not limited to the configuration shown in FIG. 2. For example, the DSB Doppler VOR transmitting device 10 may have the functional configuration shown in FIG. 8. That is, the DSB Doppler VOR transmitting device 10 shown in FIG. 8 may be provided with a beat phase monitoring circuit 17, first directivity coupler 18 configured to supply a carrier wave output from the carrier transmitter 11 to the beat phase monitoring circuit 17, second directivity coupler 19 configured to supply an upper sideband wave output from the upper sideband transmitter 12 to the beat phase monitoring circuit 17, and third directivity coupler 110 configured to supply a lower sideband wave output from the lower sideband transmitter 13 to the beat phase monitoring circuit 17. The beat phase monitoring circuit 17 shown in FIG. 8 is provided with a first mixer 171, second mixer 172, and beat phase difference detecting circuit 173.

The first mixer 171 combines the carrier wave supplied thereto from the first directivity coupler 18 with the upper sideband wave supplied thereto from the second directivity coupler 19 to thereby extract a first beat signal (+9960 Hz). The first mixer 171 outputs the extracted first beat signal to the beat phase difference detecting circuit 173.

The second mixer 172 combines the carrier wave supplied thereto from the first directivity coupler 18 with the lower sideband wave supplied thereto from the third directivity coupler 110 to extract a second beat signal (−9960 Hz). The second mixer 172 outputs the extracted second beat signal to the beat phase difference detecting circuit 173.

The beat phase difference detecting circuit 173 detects a phase difference between the first and second beat signals. Upon detection of the phase difference between the first and second beat signals, the beat phase difference detecting circuit 173 outputs a phase difference warning.

Thereby, according to the beat phase monitoring circuit 17, it becomes possible to monitor the phase state of each of the carrier wave output from the carrier transmitter 11, upper sideband wave output from the upper sideband transmitter 12, and lower sideband wave output from the lower sideband transmitter 13. That is, by virtue of the beat phase monitoring circuit 17, an amplitude-modulated wave to be formed by spatial modulation at a position distant from the DSB Doppler VOR transmitting device 10 is ensured.

It should be noted that the first monitoring device 20 removes the third IF signal derived from the lower sideband wave to thereby detect the azimuth, and hence it is not possible to monitor the operation of the lower sideband transmitter 13 by using only the first monitoring device 20. According to the beat phase monitoring circuit 17, even when the operation of the DSB Doppler VOR transmitting device 10 is to be monitored by using the first monitoring device 20, a normal operation of the lower sideband transmitter 13 is ensured.

Further, the second monitoring device 30 removes the second IF signal derived from the upper sideband wave to thereby detect the azimuth, and hence it is not possible to monitor the operation of the upper sideband transmitter 12 by using only the second monitoring device 30. According to the beat phase monitoring circuit 17, even when the operation of the DSB Doppler VOR transmitting device 10 is to be monitored by using the second monitoring device 30, a normal operation of the upper sideband transmitter 12 is ensured.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A monitoring device comprising:
a monitoring antenna configured to receive a carrier wave radiated from a carrier antenna provided to a DSB Doppler VOR transmitting device, an upper sideband wave radiated from a plurality of sideband antennas arranged to surround the carrier antenna, and a lower sideband wave radiated from the plurality of sideband antennas as a VOR signal, and wherein the upper sideband wave is higher in frequency than the carrier wave by a preset frequency, and wherein the lower sideband wave is lower in frequency than the carrier wave by the preset frequency;
a frequency converter configured to convert a frequency band of the VOR signal into an intermediate frequency (IF) band;
a filter including a passband, wherein the passband removes a component of the lower sideband wave in the frequency-converted VOR signal;
a detector configured to detect a component of the carrier wave, and a component of the upper sideband wave from the signal output from the filter; and
an azimuth detector configured to detect an azimuth based on the detected carrier wave component, and the detected upper sideband wave component.

2. A monitoring device comprising:
a monitoring antenna configured to receive a carrier wave radiated from a carrier antenna provided to a DSB Doppler VOR transmitting device, an upper sideband wave radiated from a plurality of sideband antennas arranged to surround the carrier antenna, and higher in frequency than the carrier wave by a preset frequency, and a lower sideband wave radiated from the plurality of sideband antennas, and lower in frequency than the carrier wave by the preset frequency as a VOR signal;
a frequency converter configured to convert a frequency band of the VOR signal into an intermediate frequency (IF) band;
a filter including a passband, wherein the passband removes a component of the upper sideband wave in the frequency-converted VOR signal;
a detector configured to detect a component of the carrier wave, and a component of the lower sideband wave from the signal output from the filter; and
an azimuth detector configured to detect an azimuth based on the detected carrier wave component, and the detected lower sideband wave component.

3. A Doppler VOR system comprising:
a DSB Doppler VOR transmitting device including a carrier transmitter configured to generate a carrier wave, a carrier antenna configured to radiate the carrier wave, an upper sideband transmitter configured to generate an upper sideband wave higher in frequency than the carrier wave by a preset frequency, a lower sideband transmitter configured to generate a lower sideband wave lower in frequency than the carrier wave by the preset frequency, and a plurality of sideband antennas arranged to surround the carrier antenna, and configured to radiate the upper sideband wave, and the lower sideband wave;
a first monitoring device configured to receive the carrier wave, the upper sideband wave, and the lower sideband wave as a VOR signal, remove a component of the lower sideband wave included in the VOR signal by using a first filter, and acquire an azimuth from a component of the carrier wave, and a component of the upper sideband wave; and
a second monitoring device configured to receive the VOR signal, remove the component of the upper sideband wave included in the VOR signal by using a second filter, and acquire an azimuth from the component of the carrier wave, and the component of the lower sideband wave.

4. The Doppler VOR system according to claim 3, further comprising:
a third monitoring device installed at a position separate from the carrier antenna by a preset distance, and configured to receive a VOR signal changed into an amplitude-modulated wave signal by spatial modulation, and detect an azimuth based on the received VOR signal.

5. The Doppler VOR system according to claim 3, wherein
the DSB Doppler VOR transmitting device further includes a beat phase monitoring circuit configured to monitor a phase difference between a first beat signal generated from the carrier wave generated by the carrier transmitter, and the upper sideband wave generated by the upper sideband transmitter, and a second beat signal generated from the carrier wave generated by the carrier transmitter, and the lower sideband wave generated by the lower sideband transmitter.

6. The Doppler VOR system according to claim 3, wherein
the first and second monitoring devices are installed in an facility in which the DSB Doppler VOR transmitting device is installed.
